(19) United States
(12) Patent Application Publication
(10) Pub. No.: US 2024/0283292 A1
(43) Pub. Date: Aug. 22, 2024

(54) APPARATUS AND METHOD

(71) Applicant: Sony Interactive Entertainment Inc., Tokyo (JP)

(72) Inventor: Estefania Rodriguez Quiros, London (GB)

(73) Assignee: Sony Interactive Entertainment Inc., Tokyo (JP)

(21) Appl. No.: 18/440,205

(22) Filed: Feb. 13, 2024

(30) Foreign Application Priority Data
Feb. 22, 2023 (GB) 2302496.1

(51) Int. Cl. H02J 50/10; H02J 7/00; H02J 50/40; H02J 50/80

(52) U.S. Cl. CPC H02J 50/10; H02J 7/00034; H02J 7/0013; H02J 7/0044; H02J 7/0047; H02J 50/402; H02J 50/80

(57) ABSTRACT

Apparatus includes a set of two or more user-operable control devices each configured to provide one or more respective data processing control functions, in which the control functions provided by the set of user-operable control devices are collectively configurable to provide a predetermined set of control functions; in which each user-operable control device comprises a wireless power interface to receive operative electrical power from a wireless power source; and a wireless power source configured to concurrently provide electrical power to the set of the user-operable control devices.

### BACKGROUND OF THE INVENTION

### Field of the Invention

This disclosure relates to apparatus and methods.

### Description of the Prior Art

Data processing apparatus such as computer games machines can be controlled by user-operable control devices configured to provide user input to control or at least influence the execution of data processing operations such as computer game play and/or the execution of a computer game program.

It is in this context that the present disclosure arises.

### SUMMARY OF THE INVENTION

The present disclosure provides apparatus comprising:

a set of two or more user-operable control devices each configured to provide one or more respective data processing control functions, in which the control functions provided by the set of user-operable control devices are collectively configurable to provide a predetermined set of control functions;

in which each user-operable control device comprises a wireless power interface to receive operative electrical power from a wireless power source; and

a wireless power source configured to concurrently provide electrical power to the set of the user-operable control devices.

The present disclosure also provides a set of two or more user-operable control devices each configured to provide one or more respective data processing control functions, in which the control functions provided by the set of user-operable control devices are collectively configurable to provide a predetermined set of control functions, in which each user-operable control device comprises a wireless power interface to receive operative electrical power from a wireless power source.

The present disclosure also provides a wireless power source configured to concurrently provide electrical power to a set of two or more user-operable control devices each configured to provide one or more respective data processing control functions, in which the control functions provided by the set of user-operable control devices are collectively configurable to provide a predetermined set of control functions, in which each user-operable control device comprises a wireless power interface to receive operative electrical power from the wireless power source, the wireless power source comprising:
a substrate having one or more power-providing induction elements, complementary to power-receiving induction elements of the user-operable control devices, the one or more power-providing induction elements being distributed across a region of the substrate, the region having a size sufficient for the placement of the set of user-operable control devices; and
control circuitry to allocate a respective data processing control function to a user-operable control device in dependence upon a current location of that user-operable control device on the substrate.

The present disclosure also provides a user-operable control device comprising two or more power-receiving induction elements to receive operative power from a substrate having one or more power-providing induction elements, the two or more power-receiving induction elements being disposed so that only one of the two or more power-receiving induction elements is useable at a time in dependence upon a prevailing orientation of the user-operable control device with respect to the substrate; and circuitry to detect which of the two or more power-receiving induction elements is currently in use and to vary a control function associated with the user-operable control device in dependence upon the detection.

The present disclosure also provides a method comprising: concurrently providing, using a wireless power source, electrical power to a set of two or more user-operable control devices each configured to provide one or more respective data processing control functions, in which the control functions provided by the set of user-operable control devices are collectively configurable to provide a predetermined set of control functions; and each user-operable control device receiving, using a wireless power interface, operative electrical power from the wireless power source.

The present disclosure also provides computer software comprising program code which, when executed by a computer, causes the computer to perform such a method.

The present disclosure also provides a non-transitory machine-readable storage medium which stores such computer software.

Various further aspects and features of the present disclosure are defined in the appended claims and within the text of the accompanying description.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates an example entertainment system;

FIG. 2 schematically illustrates an example of a handheld controller;

FIG. 3 is a schematic plan view of a control apparatus;

FIG. 4 is a schematic side view of the apparatus of FIG. 3;

FIGS. 5A and 5B schematically illustrate respective examples of induction elements;

FIGS. 6A to 6C schematically illustrate examples of overlap between induction elements;

FIG. 7 schematically illustrates example circuitry;

FIG. 8 schematically illustrates an example of an induction element;

FIG. 9 schematically illustrates example circuitry;

FIGS. 10 and 11 schematically illustrate examples of induction elements;

FIG. 12 schematically illustrates example circuitry;

FIGS. 13 and 14 are schematic flowcharts illustrating respective example methods;

FIG. 15 schematically illustrates example circuitry;

FIG. 16 is a schematic flowchart illustrating an example method;

FIGS. 17A, 17B and 18 schematically illustrate example user-operable control devices;

FIG. 19 schematically illustrates example circuitry; and

FIGS. 20 and 21 are schematic flowcharts illustrating respective example methods.

### DESCRIPTION OF THE EMBODIMENTS

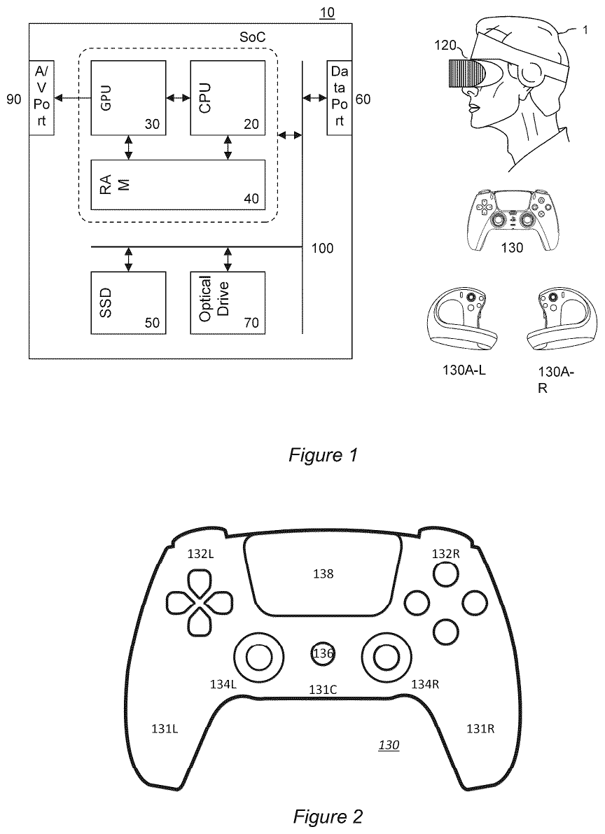

Referring now to the drawings, wherein like reference numerals designate identical or corresponding parts throughout the several views, in FIG. 1 an example of an entertainment system 10 is a games machine, computer or console such as the Sony® PlayStation 5® (PS5).

The entertainment system 10 comprises a central processor (CPU) 20. This may be a single or multi core processor, for example comprising eight cores as in the PS5. The entertainment system also comprises a graphical processing unit or GPU 30. The GPU can be physically separate to the CPU, or integrated with the CPU as a system on a chip (SoC) as in the PS5.

The entertainment device also comprises read only memory (RAM) 40, and may either have separate RAM for each of the CPU and GPU, or shared RAM as in the PS5. The or each RAM can be physically separate, or integrated as part of an SoC as in the PS5. Further storage is provided by disk storage 50, either as an external or internal hard drive, or as an external solid state drive, or an internal solid state drive as in the PS5.

The entertainment device may transmit or receive data via one or more data ports 60, such as a universal serial bus (USB) port, Ethernet® port, wireless network (Wi-Fi®) port, Bluetooth® port or similar, as appropriate. It may also optionally receive data via an optical drive 70.

Audio/visual (A/V) outputs from the entertainment device are typically provided through one or more A/V ports 90, or through one or more of the wired or wireless data ports 60.

An example of a device for displaying images output by the entertainment system is a head mounted display ‘HMD’ 120, such as the PlayStation VR 2 ‘PSVR2’, worn by a user 1.

Where components are not integrated, they may be connected as appropriate either by a dedicated data link or via a bus 100.

Interaction with the system is typically provided using one or more handheld controllers (130, 130A), such as a DualSense® controller (130) in the case of the PS5, and/or one or more virtual reality (VR) controllers (130A-L, R) in the case of the HMD.

In FIG. 2, the DualSense® controller 130 is illustrated as an example of a handheld controller. Such a controller typically has two handle sections 131L, R and a central body 131C. Various controls are distributed over the controller, typically in local groups. Examples include a left button group 132L, which may comprise directional controls and/or one or more shoulder buttons (not shown), and similarly right button group 132R, which comprise function controls and/or one or more shoulder buttons (not shown). The controller also includes left and/or right joysticks 134L, R, which may optionally also be operable as buttons by pressing down on them.

The controller may also comprise one or more system buttons 136 (typically in the central portion of the device), which typically cause interaction with an operating system of the entertainment device rather than with a game or other application currently running on it; such buttons may summon a system menu, or allow for recording or sharing of displayed content. Furthermore, the controller may comprise one or more other elements such as a touchpad 138, a light for optical tracking (not shown), a screen (not shown), haptic feedback elements (not shown), and the like.

The controller 130 of FIG. 2 can communicate with the entertainment system 10 using a wired or wireless connection (for example via the data port 60). Typically, a wireless connection is used so as to provide improved flexibility for the user of the controller to move around during gameplay.

It will also be appreciated that the controller 130 provides a comprehensive set of functions to allow for many different variations or requirements within the expected use of the entertainment system 10. For example, as discussed above, the controller 130 can provide controls for interaction with an operating system of the entertainment device. Similarly, amongst the buttons 132L, 132R and the joysticks 134L, 134R, control arrangements are provided to allow for relatively complicated or involved gameplay. In other words, not all of these controls may be required for interaction with a given computer game and in fact a subset of the controls may be sufficient for such interaction. For example, a given computer game may require only a set of directional controls similar to those provided by the buttons 132L, or may require only a set of function controls such as those provided by the buttons 132R. Here, it is noted that in the case of Sony® PlayStation® games machines, the function buttons 132R are typically denoted by geometric symbols [o, x, □, Δ].

In examples to be discussed below, it will be assumed that a computer game in use can be fully controlled (at least to a level of interaction required by a current user) by a set of user-operable controls arranged to provide the functionality of the function buttons 132R, namely buttons representing the four geometric symbols [o, x, u, A]. It will, however, be appreciated that in other examples, a set of controls for fully controlling a current computer game could require a set of directional buttons similar to those provided by the buttons 132L on the controller 130, namely [up, down, left, right] or a set of directional buttons and a set of function buttons. However, as mentioned, for the sake of the examples to be described, it will be assumed that only the function buttons are required. In the description which follows, the set of controls needed to operate a current computer game to a currently required level of interaction will be referred to as a “predetermined set of control functions”.

Techniques and apparatus will be described which can provide a simplified control arrangement implementing the predetermined set of control functions, as an alternative to the use of a relatively complicated controller 130.

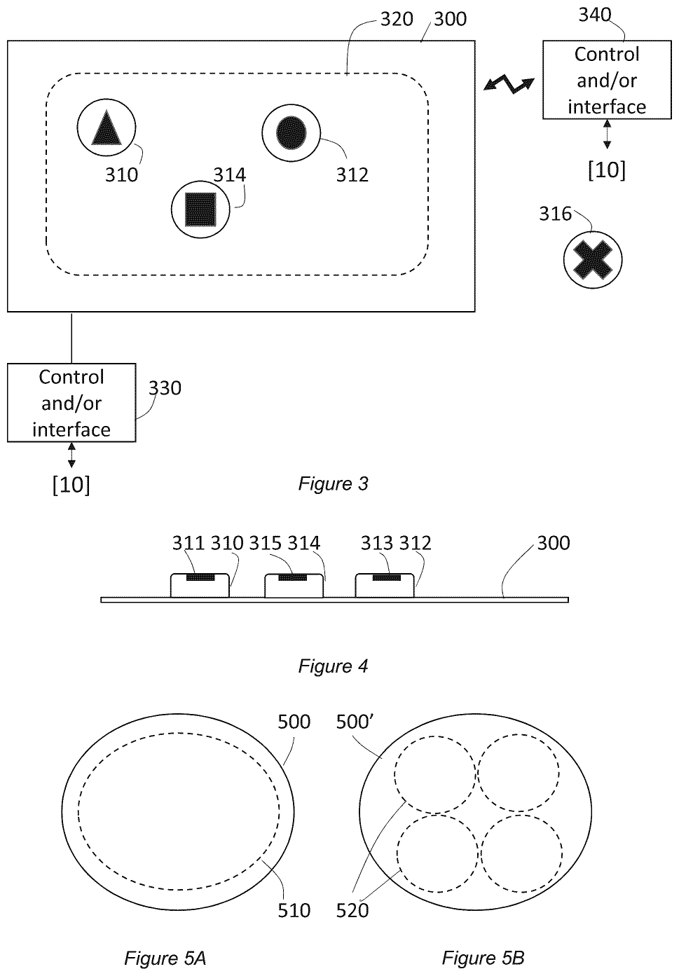

Referring to FIG. 3, a substrate 300 (such as a planar substrate, though shaped or profiled substrates could be used) acting as a so-called mat is provided. The substrate 300 acts as a wireless power source configured to concurrently provide electrical power to a set of user-operable control devices 310, 312, 314, 316 each of which is capable of being wirelessly powered by comprising a wireless power interface to receive operative electrical power from a wireless power source.

The set of two or more user-operable control devices are each configured to provide one or more respective data processing control functions, in which the control functions provided by the set of user-operable control devices are collectively configurable to provide the predetermined set of control functions as discussed above.

The substrate 300 comprises one or more power-providing induction elements, complementary to the power-receiving induction elements of the user-operable control devices, the one or more power-providing induction elements being distributed across a region 320 of the substrate, the region having a size sufficient for the placement of the set of user-operable control devices. Note that the region 320 could represent a subset of the area of the substrate 300 or could represent the whole of the area of the substrate 300. The region 320 does not have to be a contiguous region and could be provided by multiple separate sub-regions. However, the example shown in FIG. 3 provides a region 320 which is contiguous and which is smaller than the area of the substrate 300.

In general terms, when a given user-operable control device is disposed, in use, within the region of the substrate, the wireless power interface of the given user-operable control device is able to receive electrical power from one or more of the power-providing induction elements overlapping the location of the given user-operable control device.

In the example of FIG. 3, the predetermined set of control functions may be implemented by four user-operable control devices which, in the example shown, implement the functionality of the function buttons 132R and are distinguished by the four geometric symbols [o, x, o, A]. It may be seen that three of the user-operable control devices (310, 312, 314) are drawn as being currently in position on the substrate 300 (and within the region 320 in which wireless power can be provided) whereas a fourth user-operable control device 316 is not currently in position on the substrate 300.

In some examples, the user-operable control devices each have a predetermined function such as a respective one of the four geometric symbols [o, x, u, A]. In other words, for example, the user-operable control device 312 may always be associated with the [o] function. In such arrangements, in which each user-operable control device is configured to provide a predetermined respective data processing control function, the user-operable control devices can be conveniently identified and distinguished by each user-operable control device comprising one or more indicator formations configured to identify its predetermined respective data processing control function. For example, and as shown in a side view of the substrate 300 and the user-operable control devices 310, 314, 312 in FIG. 4, moulded and/or printed or painted formations 311, 313, 315 may be provided on an upper surface of each user-operable control device so as to provide a representation of the corresponding one of the four geometric symbols [o, x, a, A]. Here, references to an “upper” surface corresponds to a surface of the user-operable control device which is visible when the user-operable control device is placed on the substrate for receiving power from the substrate, for example a surface which is opposite to a surface having a power-receiving induction element.

Each of the user-operable control devices has at least a power-receiving induction element and a user-operable control such as a button or touch element. Examples of these will be discussed below. The user-operable control devices are placed on the substrate 300 and receive operative power wirelessly from the substrate 300, again using techniques to be described below. When the user operates one of the user-operable controls, in order for that user operation to influence gameplay being executed by the entertainment system 10, communication with the entertainment system 10 is provided. Various options are available and further details will be discussed below, but in brief, in some examples the wireless power provision to the user-operable control devices can also provide a wireless communication channel, such that the substrate 300 can be provided with control and/or interface circuitry 330 such that data signals received by the substrate 300 from the user-operable control devices by such a wireless communication technique can be collated and passed to the entertainment system 10 in order to mimic, emulate or act as a game controller for controlling operation of the entertainment system 10. In other examples, one or more of the user-operable control devices can communicate wirelessly with separate control and/or interface circuitry 340 which once again can collate and pass to the entertainment system signals representing those of a game controller. It is also noted that the functionality of the circuitry 340 could in fact be implemented by execution of computer software running on the entertainment system 10 such that one or more of the user-operable control devices communicates wirelessly directly with the entertainment system 10.

The provision of wireless power to a wirelessly powered device can be implemented by an electromagnetic interaction between a power-providing induction element (in this case, at the substrate 300) such as a coil or coil element disposed with respect to the substrate and carrying an alternating current and a power-receiving induction element (in this case, at a user-operable control device) in which an alternating current is induced by interaction with the field generated by the power-providing induction element when the two are close to one another.

FIGS. 5A and 5B provide examples of such power-receiving induction elements on the underside (which, in this context, implies a side or face which abuts the substrate 300 in use) of an example user-operable control device 500, 500′. In FIG. 5A, a coil element 510 is provided which occupies substantially all of the area of the underside of the user-operable control device 500. In FIG. 5B, multiple separate power-receiving induction elements 520 are provided at the underside of the user-operable control device 500′. In use, operative power may be received by any one or more of the power-receiving induction elements 520. All of the power-receiving induction elements may be enabled all of the time, or detection circuitry (not shown) can be used to select and enable one or more power-receiving induction elements currently receiving operative power.

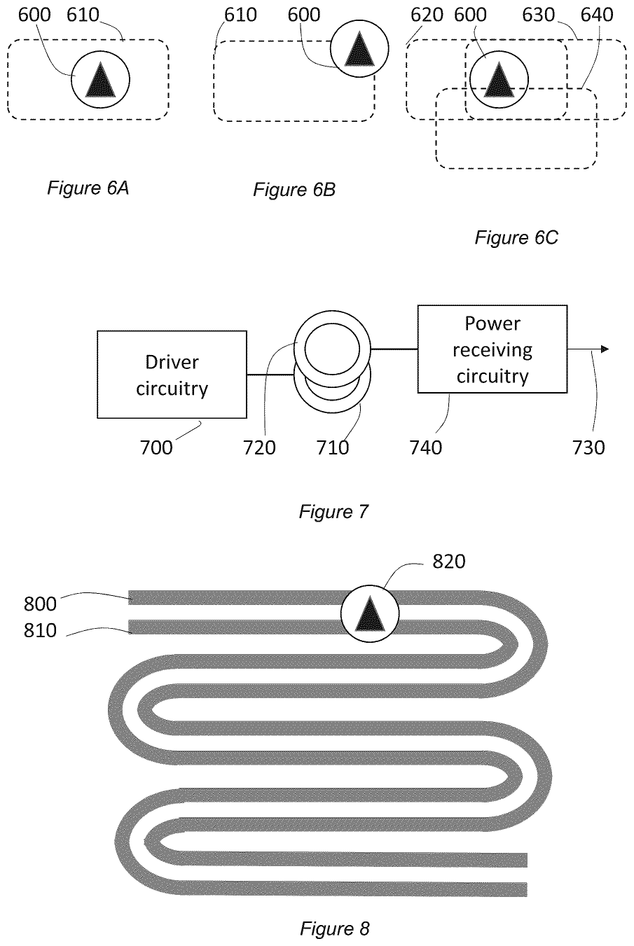

Similarly, within the region 320, one or more power-providing induction elements may be provided in the form of induction coils. FIG. 6A schematically shows an example user-operable control device 600 placed within a (or the) power-providing induction element 610 in a configuration in which the user-operable control device 600 will receive operative power when in use. Another arrangement in FIG. 6B shows the user-operable control device partially overlapping the power-providing induction element 610, and again it is possible, given sufficient overlap, for the user-operable control device 600 to receive operative power in this configuration. It is also noted that in the case of FIG. 6B, an arrangement having multiple power-receiving induction elements 520 such as that shown in FIG. 5B allows for partial overlap configurations in which at least one of the power-receiving induction elements 520 overlaps the power-providing induction element 610. In a further example of FIG. 6C, multiple power-providing induction elements 620, 630, 640 are provided which themselves may at least partially overlap within the region 320. An arrangement of multiple power-providing induction elements allows for the selective energising of only a subset of the power-providing induction elements which can reduce the power consumption and/or unwanted magnetic field generation and/or unwanted heat generation of the substrate 300 when in use.

FIG. 7 schematically represents a part of the operation of the substrate and its associated circuitry and of a user-operable control device. The substrate and/or its associated circuitry comprises driver circuitry 700 which provides an alternating current to a power-providing induction element 710. At the user-operable control device side, a power-receiving induction element 720, positioned close to and at least partially overlapping the element 710, has an alternating current induced in it by electromagnetic interaction, with this alternating current being converted to an appropriate form (such as a direct current output 730 at a required regulated voltage) by power receiving circuitry 740.

Various configurations are possible in order to provide for a region 320, large enough to have multiple user-operable control devices placed on it, so that wireless charging is provided throughout the region 320. The example of a single large power-providing induction element has been discussed above with reference to FIG. 6A. Example arrangements using multiple power-providing induction elements will be discussed below, but first, FIG. 8 schematically illustrates the use of one or more power-providing induction elements 800, 810 disposed along a curved or “snaking” path with respect to the substrate. An example user-operable control device 820 is shown overlapping the one or more power-providing induction elements 800, 810.

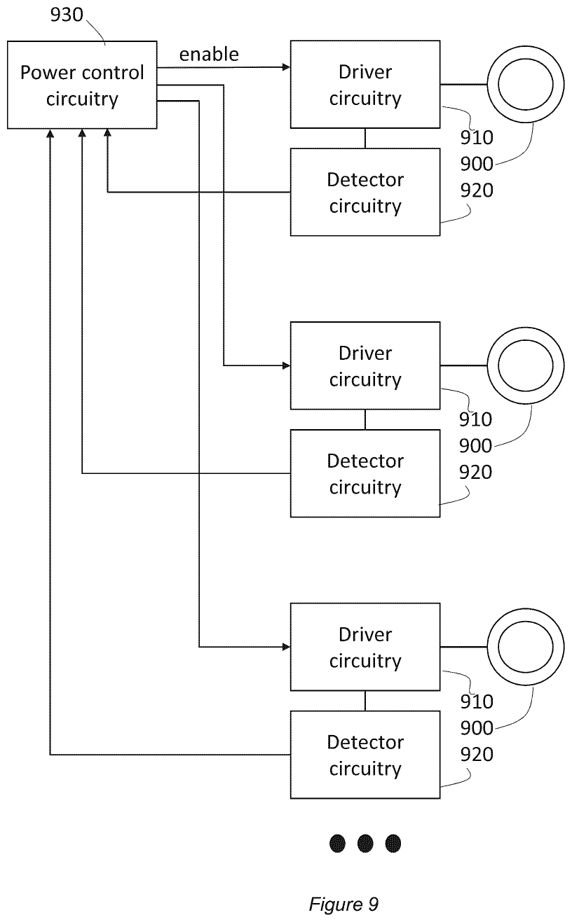

Examples will now be described in which multiple power-providing induction elements are used. In FIG. 9, three such elements 900 are shown, but this is for clarity of the diagram and in a real example many more than three such elements may be used. In the example of FIG. 9, each element has associated driver circuitry 910 and detector circuitry 920, with the driver circuitries being enabled by power control circuitry 930 which receives respective detection outputs from the detector circuitries 920. For each power-providing induction element 900, the detector circuitry 920 is configured to detect whether a user-operable control device is position so as to receive power via that power-providing induction element. This is achieved by detecting a change in load and/or impedance with respect to that power-providing induction element 900. Therefore, in use, each of the power-providing induction elements 900 can be enabled to carry a low level alternating current which is sufficient to allow for the detection of the presence of a user-operable control device as discussed above but, of itself, insufficient to power that user-operable control device for normal operation. When the presence of a user-operable control device is detected, then under the control of the power control circuitry 930, a higher level alternating current is enabled for output by that power-providing induction element for as long as the presence of the user-operable control device continues to be detected at that location.

FIG. 9 therefore provides an example of the use of two or more power-providing induction elements 900; and circuitry to detect (920) a subset of the two or more power-providing induction elements currently within an interaction range of a user-operable control device and to control (910, 930) the supply of electrical power to the detected subset of the power-providing induction elements 900.

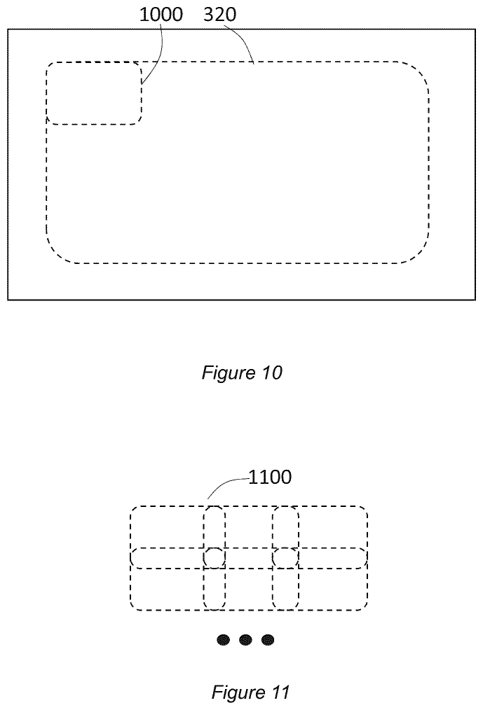

FIGS. 10 and 11 provide an example of this type of arrangement. While it is possible to use many different shapes or configurations of power-providing induction elements, a generally rectangular shape is used in FIG. 10 (which shows one such power-providing induction element 1000 within the region 320) and FIG. 11 which schematically indicates a pattern 1100 representing the overlapping of such power-providing induction elements which pattern, in practice, would fill or substantially fill the region 320.

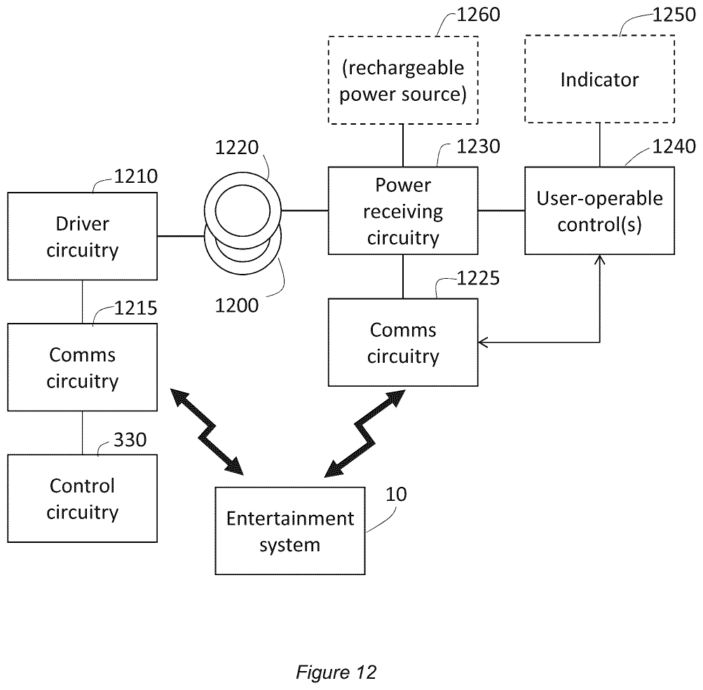

FIG. 12 schematically illustrates various other aspects of the present examples. In FIG. 12, only one power-providing induction element 1200 and associated driver circuitry 1210 is shown, but it will be appreciated that features of the circuitry of FIG. 9 could be employed such that multiple power-providing induction elements are provided and are selectively enabled as described above.

A feature of the circuitry of FIG. 12 is that different forms of communication to and from the user-operable control devices are shown. Not all of these need to be implemented in a single example, so the description of FIG. 12 should be considered as representing various alternatives which can be selectively implemented.

One technique to be described is that as well as providing for power transfer between the power-providing induction element 1200 and a nearby power-receiving induction element 1220, wireless communication can also be performed using the same elements, for example by super posing a high frequency and/or digital data signal onto the alternating current power transfer signal. This allows communication circuitry 1215, 1225 to communicate via driver circuitry 1210, the elements 1200, 1220 and power receiving circuitry 1230. In other words, the user-operable control devices may be configured to perform wireless data communication with the wireless power source via the power-receiving induction elements and the power-providing induction elements.

In a first example, the communications circuitry 1215 can be used—in the case that each user-operable control device has a predetermined control functionality—to query a currently powered user-operable control device to find out what that functionality is. The control circuitry 330 can perform various actions in response to this information, such as one or both of: (a) checking, and confirming to the entertainment system 10, whether all of the user-operable control devices needed to implement the predetermined set of control functions are present; (b) in the case that one or more user-operable control devices needed to implement the predetermined set of control functions is not present on the substrate 300, transmitting (by a separate wireless link not reliant upon the power transfer system such as a Bluetooth® link) an instruction to a currently missing user-operable control device to display an indication to the user that the device needs to be placed on the substrate 300; (c) to differentiate between the case when all of the user-operable control devices needed to implement the predetermined set of control functions are present and the case when they are not all present, communicating an instruction to those user-operable control devices which are present to display an indication differentiating these situations.

The arrangement therefore provides an example of the use of control circuitry 330 (with 1215, 1225) to detect when some but not all of the set of user-operable control devices are located on the substrate and to generate an indication to the user of which of the set of user-operable control devices are not currently located on the substrate. To implement this,

each of the set of user-operable control devices comprises an indicator 1250 which can be selectively illuminated and a rechargeable power source 1260 to provide electrical power for at least the illumination of the indicator; and the generated indication comprises illumination of an indicator at a user-operable control device not currently located on the substrate.

In a second example, the communication path from the communication circuitry 1225 to the communication circuitry 1215 can be used to provide information to the entertainment system 10 indicative of user actions at each of the user-operable control devices, or in other words the data signals to mimic, emulate or act as a game controller.

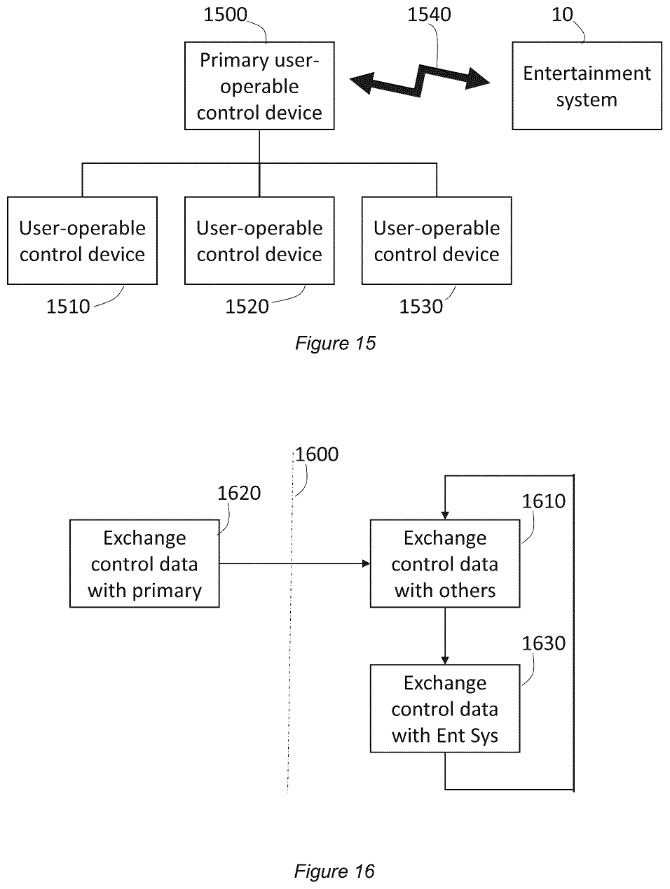

Note that as an alternative data path to the entertainment system 10, the communication circuitry 1225 of one or more of the user-operable control devices can communicate directly with the entertainment system 10. Or in other examples such as that to be discussed with respect to FIGS. 15 and 16 below, a subset such as one of the user-operable control devices can act as a primary device which communicates with others of the user-operable control devices to receive their information indicative of user actions at those devices, with the primary device collating these data signals into a data signal for communication to the entertainment system 10 by the communication circuitry 1225 of the primary device, the data signal mimicking, emulating or acting as an input from a game controller.

Further features shown in FIG. 12 include one or more user-operable controls 1240, optional indicator circuitry 1250 such as one or more optical indicators and associated driver circuitry and an optional rechargeable power source 1260. The rechargeable power source can be used simply to power the communication circuitry 1225 and indicator circuitry 1250 in order to allow for the indication to be displayed that a given user-operable control device is currently not in place on the substrate 300.

In other arrangements, control functions can be allocated to user-operable control devices, for example in dependence upon the location at which they are placed on the substrate 300. For example, where a set of four user-operable control devices are intended to mimic the functionality of the buttons carrying geometric symbols [o, x, u, 4], it is noted that these buttons have a usual associated orientation relative to one another. For example, the triangle symbol is normally at the top (as viewed by the user in use) of the set of four respective buttons. Therefore, in some examples, when a set of four user-operable control devices are present on the substrate, the triangle button function is allocated to the user-operable control device nearest a predetermined edge of the substrate 300 (for example an edge printed or embossed or otherwise indicated as a top edge of the substrate). This arrangement makes use of a system as discussed above in which multiple power-providing induction elements are provided, along with detection circuitry to detect which ones are actually in use.

In an arrangement in which control functions are allocated in this manner, the user-operable control devices would not be expected to have predetermined indications on their upper surface of the type discussed with reference to FIG. 4, but instead the one or more indicators 1250 could be configurable to display the currently allocated function as communicated to that user-operable control device.

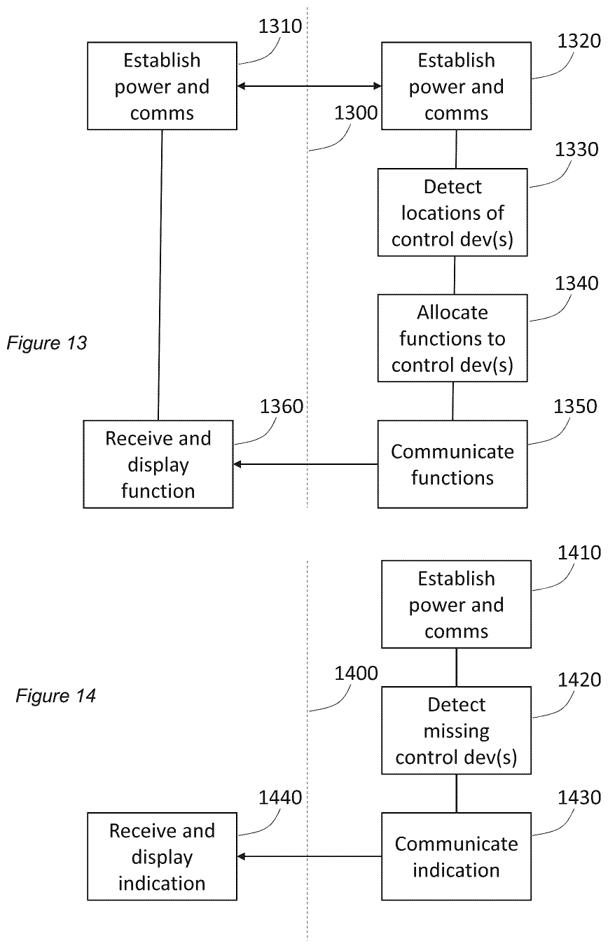

FIG. 13 is a schematic flowchart illustrating a method, in which steps to the left of a schematic divider 1300 are performed at a user-operable control device, and steps to the right of the schematic divider 1300 are performed at the substrate 300 and its associated circuitry.

At steps 1310, 1320, power and communication transfer is established between the substrate 300 and the user-operable control device. At a step 1330, the location of the user-operable control device is detected, using the techniques described above for detecting which power-providing induction elements are in use and the communication techniques also described above. In response to the detected location of each of the user-operable control devices, at a step 1340 the control circuitry 330 allocates a function to each user-operable control device, for example based upon a predetermined pattern or set of parameters such as allocating a respective function to the user-operable control device closest to each of the edges of the substrate 300. At a step 1350 the allocated functions are communicated to each user-operable control device which, at a step 1360, receives and displays the respective function. After that, data generated in respect of user actions at that user-operable control device is associated with the allocated function.

In other words, the arrangement provides 330 control circuitry to allocate a respective data processing control function to a user-operable control device in dependence upon a current location of that user-operable control device on the substrate.

FIG. 14 described in more detail the arrangement mentioned above in which an indication can be provided of currently missing user-operable control devices. Once again, a schematic divider 1400 is provided with the same notation being used for operations either side of the schematic divider.

At a step 1410, power and communication is established with user-operable control devices currently in place on the substrate 300. At a step 1420 the control circuitry 330 detects which user-operable control devices which are required to implement the predetermined set of control functions are not currently present on the substrate 300 and at a step 1430 communicates an indication signal to the not-present user-operable control device(s) which, at a step 1440 receive and display the indication.

FIGS. 15 and 16 provide more information about the use of a primary user-operable control device 1500 to receive and collate data signals from other user-operable control devices 1510, 1520, 1530 . . . with its own data signal, or relating to user actions at those user-operable control devices, to generate a composite data signal 1540 for communication with the entertainment system 10. If the entertainment system 10 has any information to pass back to the user-operable control devices, it can similarly communicate with the primary user-operable control device 1500 for that information to be distributed to the appropriate one or more of the other user-operable control devices.

FIG. 16 is a schematic flowchart illustrating a method, once again using a notation around a schematic divider 1600, though in this example steps to the right of the schematic divider are performed by the primary user-operable control device 1500 and steps to the left by another of the user-operable control devices.

At a step 1610 the primary user-operable control device exchanges control data with the other user-operable control devices (which each execute a corresponding step 1620. At a step 1630 the primary user-operable control device exchanges control data with the entertainment system 10.

This therefore provides an example in which the set of two or more user-operable control devices comprise a primary user-operable control device 1500 and one or more secondary user-operable control devices 1510, 1520, 1530 . . . ; in which the primary user-operable control device is configured to communicate wirelessly with the one or more secondary user-operable control devices and to generate a composite output data signal indicative of user actions at each of the set of two or more user-operable control devices. The overall system may comprise data processing apparatus such as the entertainment system 10 to perform a data processing operation such as a game processing operation and/or the execution of a computer game program in response to the output signal generated by the primary user-operable control device.

Note that as an alternative to the primary user-operable control device performing this collation of the data signals, the collation can be performed by the control circuitry 330 and/or by the entertainment system 10, each providing an example of data processing apparatus having circuitry to receive a respective output signal from each of the set of user-operable control devices indicative of user actions at that user-operable control device, to generate a controller emulation signal from the received output signals and to perform a data processing operation in response to the controller emulation signal.

A further group of example arrangements will now be described. In these examples, one or more of the user-operable control devices comprises two or more power-receiving induction elements disposed so that only one of the two or more power-receiving induction elements is useable at a time in dependence upon a prevailing orientation of the user-operable control device with respect to the substrate; and circuitry to detect which of the two or more power-receiving induction elements is currently in use and to vary a control function associated with the user-operable control device in dependence upon the detection.

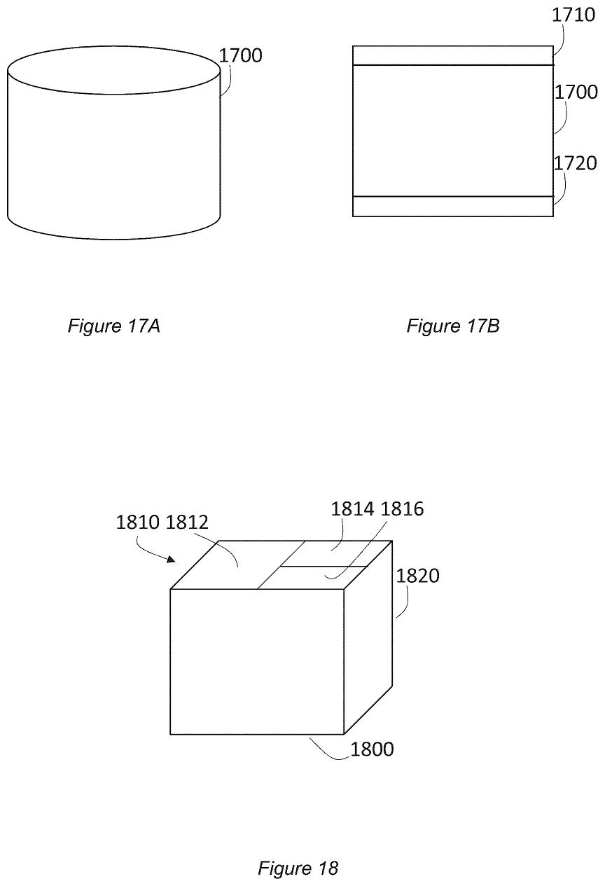

FIGS. 17A and 17B illustrate, in perspective view and side view respectively, a generally cylindrically shaped user-operable control device 1700. The generally cylindrical shape allows the user-operable control device 1700 to be placed on the substrate 300 in one of two orientations (which may be referred to as “upwards” or “downwards”). As shown by the side view in FIG. 17B, a power-receiving induction element 1710, 1720 is provided at each of the flat faces of the generally cylindrical shape so that in dependence upon whether the user-operable control device is positioned in the upwards or the downwards orientation, one, but not the other, of the power-receiving induction elements 1710, 1720 will be adjacent to the substrate 300 and will receive operative power from the substrate 300. A simple detection of which of the power-receiving induction element 1710, 1720 is currently receiving operative power provides an indication of which way up the user-operable control device is currently placed. This in turn allows different functionality to be associated (for example, in a predetermined manner) with the user-operable control device according to its prevailing orientation is detected using these techniques. For example, a user-operable control device could be provided in which it performs a function associated with the triangle button when it is placed upwards on the substrate 300, or a function associated with a directional “up” button when it is placed downwards upon the substrate. Therefore, user-operable controls and function indicators (printed, embossed or configurable) can be provided at each of the upper and lower faces of the user-operable control device so that in either orientation, the exposed control and function indicator refers to the prevailing function when the obscured (underneath) power-receiving induction element is adjacent to the substrate 300.

FIG. 18 shows a similar arrangement in which more than two faces may be provided with power-receiving induction elements. For a given face 1800 of an example cube-shaped device 1820 placed adjacent to the substrate 300, the opposite face 1810 provides both an indication of the prevailing function and a user control such as a touch control. In some examples, these functions could be spatially separated or at least partially overlapping on the exposed face in order to avoid unwanted conflicts of circuitry and/or functionality. For example, the power-receiving induction element on the upper face 1810 (which of course is not in active use when the face 1810 is uppermost but is in active use when the face 1810 is adjacent the substrate 300) could be disposed in a portion 1812 of the face, the user (for example, touch) control in a portion 1814 and the indicator in a portion 1816. In some examples, the indicator and control on a given face could be disabled (for example, by circuitry 1900 to be described below) when the power-receiving induction element on that same face is in active use.

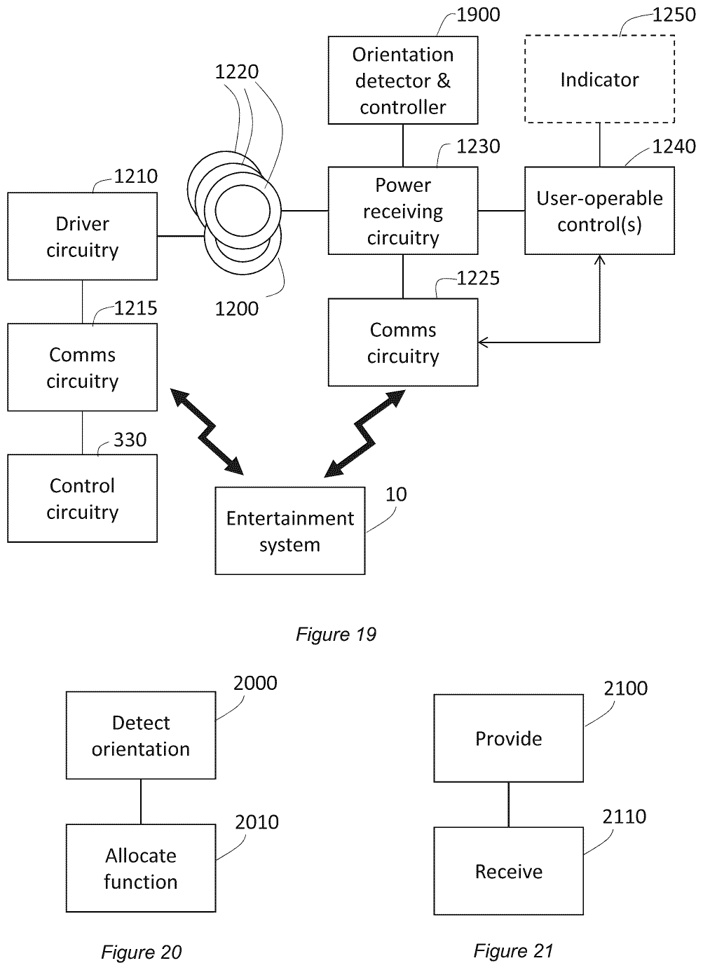

FIG. 19 schematically illustrates example circuitry, similar in many respects to the circuitry of FIG. 12, and indeed only substantive differences will be described here.

In contrast to FIG. 12, multiple power-receiving induction elements are provided at the user-operable control device, each corresponding to a respective orientation of the user-operable control device as discussed above. An orientation detector 1900 works with the power receiving circuitry 1230 and/or the communication circuitry 1225 to detect a prevailing orientation of the user-operable control device with respect to the substrate 300 and to control the allocation of a control function to the user-operable control device in response to the detected orientation. The detected function can also be transmitted to the entertainment system 10 and/or to the control circuitry 330 using techniques described above.

Example arrangements also therefore provide a user-operable control device comprising two or more power-receiving induction elements to receive operative power from a substrate having one or more power-providing induction elements, the two or more power-receiving induction elements being disposed so that only one of the two or more power-receiving induction elements is useable at a time in dependence upon a prevailing orientation of the user-operable control device with respect to the substrate; and circuitry to detect which of the two or more power-receiving induction elements is currently in use and to vary a control function associated with the user-operable control device in dependence upon the detection.

The detection of which power-receiving induction element is in use avoids the need for accelerometers or other types of orientation detectors. In other examples, however, such a detector could be used, and its output used to enable the appropriate power-receiving induction element for operation as well as to influence the allocation of a function.

FIG. 20 is a schematic flowchart illustrating an example method relating to these techniques in which, at a step 2000 the user-operable control device detects its orientation with respect to the substrate 300, for example by detecting which of multiple power-receiving induction elements is currently in use and at a step 2010 allocates a function to operation of the user operable control device in dependence upon the detected orientation.

FIG. 21 is a schematic flowchart illustrating an example method comprising: concurrently providing (at a step 2100), using a wireless power source, electrical power to a set of two or more user-operable control devices each configured to provide one or more respective data processing control functions, in which the control functions provided by the set of user-operable control devices are collectively configurable to provide a predetermined set of control functions; and each user-operable control device receiving (at a step 2110), using a wireless power interface, operative electrical power from the wireless power source.

In so far as embodiments of the disclosure have been described as being implemented, at least in part, by software-controlled data processing apparatus such as the entertainment system 10, it will be appreciated that a non-transitory machine-readable medium carrying such software, such as an optical disk, a magnetic disk, semiconductor memory or the like, is also considered to represent an embodiment of the present disclosure. Similarly, a data signal comprising coded data generated according to the methods discussed above (whether or not embodied on a non-transitory machine-readable medium) is also considered to represent an embodiment of the present disclosure.

It will be apparent that numerous modifications and variations of the present disclosure are possible in light of the above teachings. It is therefore to be understood that within the scope of the appended clauses, the technology may be practised otherwise than as specifically described herein.

1. Apparatus comprising:
a set of two or more user-operable control devices each configured to provide one or more respective data processing control functions, in which the control functions provided by the set of user-operable control devices are collectively configurable to provide a predetermined set of control functions;
in which each user-operable control device comprises a wireless power interface to receive operative electrical power from a wireless power source; and
a wireless power source configured to concurrently provide electrical power to the set of the user-operable control devices.

2. The apparatus of claim 1, in which:
the wireless power interface of each user-operable control device comprises one or more power-receiving induction elements; and
the wireless power source comprises a substrate having one or more power-providing induction elements, complementary to the power-receiving induction elements of the user-operable control devices, the one or more power-providing induction elements being distributed across a region of the substrate, the region having a size sufficient for the placement of the set of user-operable control devices.

3. The apparatus of claim 2, in which, when a given user-operable control device is disposed, in use, within the region of the substrate, the wireless power interface of the given user-operable control device is able to receive electrical power from one or more of the power-providing induction elements overlapping the location of the given user-operable control device.

4. The apparatus of claim 2, in which the one or more power-providing induction elements each comprise an induction coil disposed with respect to the substrate.

5. The apparatus of claim 2, in which the one or more power-providing induction elements are disposed along a curved path with respect to the substrate.

6. The apparatus of claim 2, in which the wireless power source comprises:
two or more power-providing induction elements; and
circuitry to detect a subset of the two or more power-providing induction elements currently within an interaction range of a user-operable control device and to control the supply of electrical power to the detected subset of the power-providing induction elements.

7. The apparatus of claim 2, in which the user-operable control devices are configured to perform wireless data communication with the wireless power source via the power-receiving induction elements and the power-providing induction elements.

8. The apparatus of claim 2, comprising control circuitry to detect when some but not all of the set of user-operable control devices are located on the substrate and to generate an indication to the user of which of the set of user-operable control devices are not currently located on the substrate.

9. The apparatus of claim 8, in which:
each of the set of user-operable control devices comprises an indicator which can be selectively illuminated and a rechargeable power source to provide electrical power for at least the illumination of the indicator; and
the generated indication comprises illumination of an indicator at a user-operable control device not currently located on the substrate.

10. The apparatus of claim 2, comprising control circuitry to allocate a respective data processing control function to a user-operable control device in dependence upon a current location of that user-operable control device on the substrate.

11. The apparatus of claim 1, in which each user-operable control device is configured to provide a predetermined respective data processing control function.

12. The apparatus of claim 11, in which each user-operable control device comprises one or more indicator formations configured to identify its predetermined respective data processing control function.

13. The apparatus of claim 1, in which one or more of the user-operable control devices comprises two or more power-receiving induction elements disposed so that only one of the two or more power-receiving induction elements is useable at a time in dependence upon a prevailing orientation of the user-operable control device with respect to the substrate; and circuitry to detect which of the two or more power-receiving induction elements is currently in use and to vary a control function associated with the user-operable control device in dependence upon the detection.

14. The apparatus of claim 1, in which the set of two or more user-operable control devices comprise a primary user-operable control device and one or more secondary user-operable control devices;
in which the primary user-operable control device is configured to communicate wirelessly with the one or more secondary user-operable control devices and to generate a composite output data signal indicative of user actions at each of the set of two or more user-operable control devices.

15. The apparatus of claim 14, comprising data processing apparatus to perform a data processing operation in response to the output signal generated by the primary user-operable control device.

16. The apparatus of claim 1, comprising data processing apparatus having circuitry to receive a respective output signal from each of the set of user-operable control devices indicative of user actions at that user-operable control device, to generate a controller emulation signal from the received output signals and to perform a data processing operation in response to the controller emulation signal.

17. The apparatus of claim 14, in which:
the data processing apparatus is a computer games machine; and
the data processing operation comprises execution of a computer game program.

18. An apparatus, comprising:
a set of two or more user-operable control devices each configured to provide one or more respective data processing control functions, wherein:
the control functions provided by the set of user-operable control devices are collectively configurable to provide a predetermined set of control functions, and
each user-operable control device comprises a wireless power interface to receive operative electrical power from a wireless power source.

19. A wireless power source configured to concurrently provide electrical power to a set of two or more user-operable control devices each configured to provide one or more respective data processing control functions, in which the control functions provided by the set of user-operable control devices are collectively configurable to provide a predetermined set of control functions, in which each user-operable control device comprises a wireless power interface to receive operative electrical power from the wireless power source, the wireless power source comprising:
a substrate having one or more power-providing induction elements, complementary to power-receiving induction elements of the user-operable control devices, the one or more power-providing induction elements being distributed across a region of the substrate, the region having a size sufficient for the placement of the set of user-operable control devices; and
control circuitry to allocate a respective data processing control function to a user-operable control device in dependence upon a current location of that user-operable control device on the substrate.

20. A user-operable control device comprising:
two or more power-receiving induction elements to receive operative power from a substrate having one or more power-providing induction elements, the two or more power-receiving induction elements being disposed so that only one of the two or more power-receiving induction elements is useable at a time in dependence upon a prevailing orientation of the user-operable control device with respect to the substrate; and
circuitry to detect which of the two or more power-receiving induction elements is currently in use and to vary a control function associated with the user-operable control device in dependence upon the detection.

21. A method comprising:
concurrently providing, using a wireless power source, electrical power to a set of two or more user-operable control devices each configured to provide one or more respective data processing control functions, in which the control functions provided by the set of user-operable control devices are collectively configurable to provide a predetermined set of control functions; and
each user-operable control device receiving, using a wireless power interface, operative electrical power from the wireless power source.

22. A non-transitory machine-readable storage medium which stores computer software comprising program code which, when executed by a computer, causes the computer to perform a method comprising:
concurrently providing, using a wireless power source, electrical power to a set of two or more user-operable control devices each configured to provide one or more respective data processing control functions, in which the control functions provided by the set of user-operable control devices are collectively configurable to provide a predetermined set of control functions; and
each user-operable control device receiving, using a wireless power interface, operative electrical power from the wireless power source.

23. (canceled)
